(19) United States
(12) Patent Application Publication
(10) Pub. No.: US 2024/0376837 A1
(43) Pub. Date: Nov. 14, 2024

(54) CRANKCASE VENTILATION FILTERS WITH AXIAL SEAL MEMBER

(71) Applicant: Cummins Filtration Inc., Nashville, TN (US)

(72) Inventors: Chirag D. Parikh, Madison, WI (US); Mark V. Holzmann, Stoughton, WI (US); Ken Tofsland, Stoughton, WI (US); Rajath Martin, Madison, WI (US); Xuerui Gu, Fitchburg, WI (US); Joseph Appelhans, Belvidere, IL (US); Ganesh Ram Ramanujam Karthikeyan, Austin, TX (US)

(73) Assignee: Cummins Filtration Inc., Nashville, TN (US)

(21) Appl. No.: 18/682,280

(22) PCT Filed: Aug. 8, 2022
(86) PCT No.: PCT/US2022/039681

§ 371 Date: Feb. 8, 2024

Related U.S. Application Data
(60) Provisional application No. 63/230,936, filed on Aug. 9, 2021.
(60) Provisional application No. 63/335,817, filed on Apr. 28, 2022.

(51) Int. Cl. F01M 13/04; B01D 46/00; B01D 46/24

(52) U.S. Cl. CPC F01M 13/04; B01D 46/0041; B01D 46/0056; B01D 46/2414; B01D 2265/028; B01D 2265/04; B01D 2271/022; B01D 2279/35; F01M 2013/0438

(57) ABSTRACT

A rotating crankcase ventilation filter element comprises a filter media comprising a plurality of filter media layers. A first endcap is positioned on a filter media first end of the filter media, and a second endcap positioned on a filter media second end of the filter media. the second endcap coupled to the first endcap such that the first endcap and the second endcap define an internal volume within which the filter media is disposed. The second endcap comprises an axial seal member extending from a surface of the second endcap towards the filter media and forming an axial seal with the filter media. The axial seal member projects substantially parallel to a direction of axial fluid flow entering the filter media.

### CROSS-REFERENCE TO RELATED PATENT APPLICATIONS

This application is a national phase of PCT Application No. PCT/US2022/039681, filed Aug. 8, 2022, which claims priority to U.S. Provisional Application No. 63/230,936, filed Aug. 9, 2021. The contents of these applications is incorporated herein by reference in its entirety.

### TECHNICAL FIELD

The present disclosure relates generally to filters for use with internal combustion engine systems.

### BACKGROUND

During operation of an internal combustion engine, a fraction of combustion gases can flow out of the combustion cylinder and into the crankcase of the engine. These gases are often called “blowby” gases. The blowby gases include a mixture of aerosols, oils, and air. If vented directly to the ambient, the aerosols contained in the blowby gases can potentially harm the environment. Accordingly, the blowby gases are often routed out of the crankcase via a crankcase ventilation system. The crankcase ventilation system may pass the blowby gases through a coalescer (i.e., a coalescing filter element) to remove most or all of the aerosols and oils contained in the blowby gases. The filtered blowby gases (“clean” gases) are then either vented to the ambient (in open crankcase ventilation systems) or routed back to the air intake for the internal combustion engine for further combustion (in closed crankcase ventilation systems).

Some crankcase ventilation systems utilize rotating crankcase ventilation filter elements, for example, rotating coalescer elements that increase the filter efficiency of crankcase ventilation systems by rotating the coalescer element during filtering. In rotating coalescer elements, the contaminants (e.g., oil droplets suspended and transported by blowby gases) are separated at least in part by centrifugal separation techniques. Additionally, the rotation of the coalescer element can create a pumping effect, which reduces the pressure drop through the crankcase ventilation system.

Some rotating crankcase ventilation filter element may include a corrugated and/or wound axial filter media layers, for example, a filter media layer wound into a roll. The blowby gases flow from upstream side to downstream side of the wound axial flow media and are generally sealed via radial interference between the filter media and an endcap located at the upstream side of the filter element. However, this interference may cause an uneven collapse of the axial flow channels. Due to uneven collapse of the flow channels, the filter media can get loaded with contaminants unevenly, which can cause filter element to go out of balance. This imbalance can cause whirling during rotation of the crankcase ventilation filter element, which can cause higher loading on bearings supporting the filter element and an eventual failure thereof.

### SUMMARY

Embodiments described herein relate generally to systems and methods for sealing a filter media of a filter element to prevent by pass of blowby gases, and in particular, to first and second endcaps positioned on axial ends of the filter media, and an axial seal member projecting from the second endcap towards the filter media so as to form an axial seal therewith.

In a set of embodiments, a rotating crankcase ventilation filter element comprises a filter media. A first endcap is positioned on a filter media first end of the filter media, and a second endcap positioned on a filter media second end of the filter media, the second endcap coupled to the first endcap such that the first endcap and the second endcap define an internal volume within which the filter media is disposed. The second endcap comprises an axial seal member extending from a surface of the second endcap towards the filter media and forming an axial seal with the filter media. The axial seal member projects substantially parallel to a direction of axial fluid flow entering the filter media.

Another set of embodiments relate to a crankcase ventilation system. The crankcase ventilation system includes a housing having an inlet that receives a fluid and an outlet, and a rotating crankcase ventilation filter element. The rotating crankcase ventilation filter element includes a filter media, a first endcap, and a second endcap. The first endcap is positioned on a filter media first end of the filter media. The second endcap is positioned on a filter media second end of the filter media. The second endcap is coupled to the first endcap such that the first endcap and the second endcap define an internal volume within which the filter media is disposed. The second endcap includes an axial seal member that extends from a surface of the second endcap towards the filter media and forming an axial seal with the filter media. The axial seal member projects substantially parallel to a direction of axial fluid flow entering the filter media.

Yet another set of embodiments relate to a rotating crankcase ventilation filter element. The rotating crankcase ventilation filter element includes a filter media and an endcap. The endcap is positioned on a filter media end of the filter media. The endcap includes an axial seal member and a sidewall. The axial seal member extends from a surface of the endcap towards the filter media and forms an axial seal with the filter media. The axial seal member projects substantially parallel to a direction of axial fluid flow entering the filter media. The sidewall extends from an outer periphery of the endcap towards the filter media. A radial gap is defined between the sidewall and a radially outer surface of the filter media.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a cross-sectional view of a crankcase ventilation system, according to an embodiment.

FIG. 2A is a side, cross-sectional perspective view of a crankcase ventilation system, according to another embodiment.

FIG. 2B is a side cross-section view of a filter element that may be included in the crankcase ventilation system of FIG. 2A, according to an embodiment.

FIG. 2C is a side cross-section view of a portion of the filter element of FIG. 2B indicated by the arrow A in FIG. 2B.

FIG. 2D is a top view of a portion of a filter media that may be included in the filter element of FIG. 2B.

FIG. 3 is a side cross-section view of a filter element, according to another embodiment.

FIG. 4 is a side cross-section view of a portion of the filter element of FIG. 3 indicated by the arrow B in FIG. 3.

FIG. 5 is perspective cross-section view of the portion of the filter element of FIG. 3 indicated by the arrow B in a first configuration.

FIG. 6 is a perspective cross-section view of the portion of filter element of FIG. 5 in another configuration.

FIG. 7 is a plot of the out of balance rate of increase based on an accelerated plugging test for a second endcap of a filter element that forms a radial seal with the filter media included in the filter element, a second endcap according to the present disclosure that forms an axial seal via a triangular axial seal member, and another second endcap according to the present disclosure that forms an axial seal via a flat axial seal member, with the filter media included in the filter element.

FIG. 8 is a plot of separation or filtering efficiency of a filter element that forms an axial seal as a function of an interference depth of an axial seal member of the filter element with a filter media of the filter element.

FIG. 9A is a side cross-section view of a crankcase ventilation system, according to another embodiment.

FIG. 9B is a side cross-section view of the crankcase ventilation system of FIG. 9A.

FIG. 9C is a side cross-section view of a portion of the filter element of FIGS. 9A and 9B.

FIG. 10A is a side cross-section view of a filter element that may be included in any of the crankcase ventilation system described herein, according to an embodiment.

FIG. 10B is a side cross-section view of a portion of the filter element of FIG. 10A indicated by the arrow C.

FIG. 11A is a side cross-section view of a filter element that may be included in any of the crankcase ventilation system described herein, according to an embodiment.

FIG. 11B is a side cross-section view of a portion of the filter element of FIG. 11A indicated by the arrow D.

FIG. 12 is a side cross-section view of a snap fit feature that may be included in the filter element of FIG. 10A or 10B, according to an embodiment.

FIGS. 13A-13C are side cross-section views of the snap fit feature of FIG. 12, according to various embodiments.

FIG. 14 is a side cross-section view of a filter element that may be included in any of the crankcase ventilation system described herein, according to an embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate generally to systems and methods for sealing a filter media of a filter element to prevent by pass of blowby gases, and in particular, sealing the filter media to first and second endcaps positioned on axial ends of the filter media, and an axial seal member projecting from the second endcap towards the filter media so as to form an axial seal therewith.

Some rotating crankcase ventilation filter element may include a corrugated and/or wound axial filter media layers, for example, a filter media layer wound into a roll. The blowby gases flow from an upstream side to a downstream side of the wound axial flow media and are generally sealed via radial interference between the filter media and an endcap located at the upstream side of the filter element. However, this interference may cause an uneven collapse of the axial flow channels. Due to uneven collapse of the channel, the filter media can get loaded with contaminants unevenly, which can cause filter element to go out of balance. For example, the filter media can include corrugated wound media, and radial interference of the endcap to an outside radial surface of the filter media may cause a radial collapse of corrugated channels.

These channels are subjected to engine blowby gas flow that may contain contaminations observed in engine blowby flow. These contaminations can load over time in these channels. The channel collapse can be uneven, which can cause uneven loading of the contamination at different locations of the filter media over time. In rotating crankcase ventilation systems, these filter elements can spin at high speed for separating aerosol from blowby gas stream. As a result, the uneven loading of channels can cause out of balance creep over time. This creep can result into higher loads on bearing and reduce bearing life.

In contrast, embodiments of the rotating crankcase ventilation filter elements described herein, which include an endcap that forms an axial seal with the filter media, may provide one or more benefits including, for example: (1) preventing uneven collapse of the channels of the filter media via formation of the axial seal; (2) reducing risk of out of balance creep of the filter media; and (3) reducing bearing loads, thereby reducing service intervals, warranty issues and maintenance costs, and increasing life of the filter element.

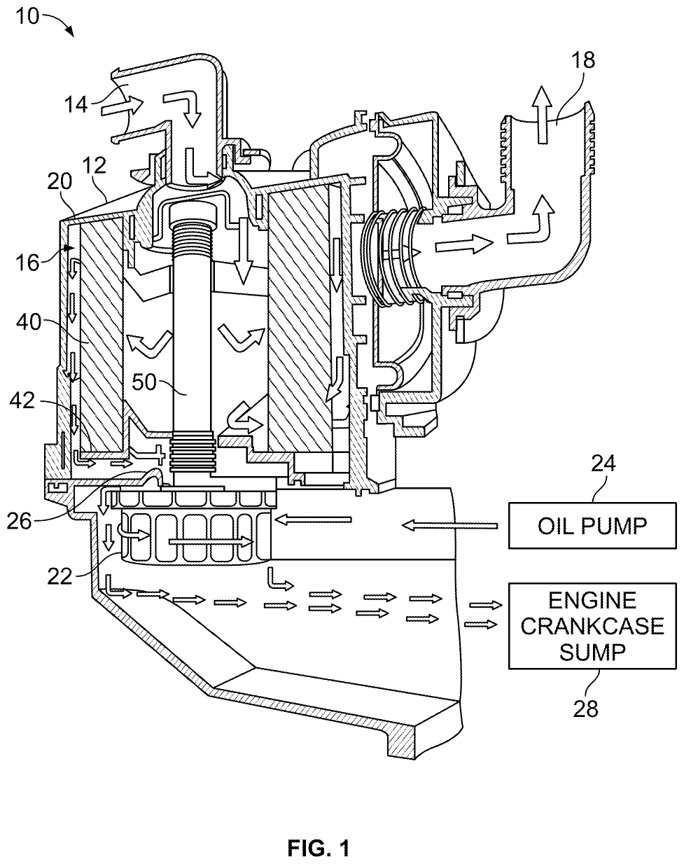

Referring to FIG. 1, a cross-sectional view of a crankcase ventilation system 10 is shown according to an example embodiment. The crankcase ventilation system 10 includes a rotating crankcase ventilation filter element 16 (e.g., a rotating coalescer element) driven by a pressurized fluid or a motor. The crankcase ventilation system 10 generally processes blowby gases received from an internal combustion engine crankcase to remove aerosols, oils, and other particulate contained in the crankcase blowby gases. The crankcase ventilation system 10 generally includes a housing 12 having an inlet 14 that receives crankcase blowby gases to be filtered (e.g., from a crankcase of an internal combustion engine), a central compartment having a rotating crankcase ventilation filter element 16, for example, a rotating coalescer element installed therein, and an outlet 18 that provides filtered blowby gases to the internal combustion engine (in a closed crankcase ventilation system) or to the ambient (in an open crankcase ventilation system).

During operation of the crankcase ventilation system 10, blowby gases enter the housing 12 through the inlet 14. The blowby gases are directed to the central compartment where the blowby gases flow through the filter element 16 in an inside-out manner. In an alternate arrangement, the crankcase ventilation system 10 can be configured to have an outside-in flow arrangement. The filter element 16 may be coupled to a central shaft 50 that transfers rotation to the filter element 16. The central shaft 50 may be rotationally driven by a turbine 22 that is rotated by a jet of oil generated by an oil pump 24. The turbine 22 may be an impulse turbine. In other embodiments, the central shaft 50 may be driven by an electric motor. As the filter element 16 rotates, the filter element 16 (e.g., a rotating coalescer element) separates oil, aerosols, and other contaminants contained in the blowby gases. The separated contaminants drain from the housing 12 through a drain 26 and return to the engine crankcase sump 28. The filter element 16 may include a first endcap 20, a second endcap 42, and a filter media 40 (e.g., a separating device). In various embodiments, the filter media 40 may comprise a corrugated and wound filter media configured for axial flow such as the filter element 100, or 200 described in further detail below. For example, the filter media 40 may include a plurality of filter media layers formed by winding or rolling a single layer of filter media into a cylindrical shape.

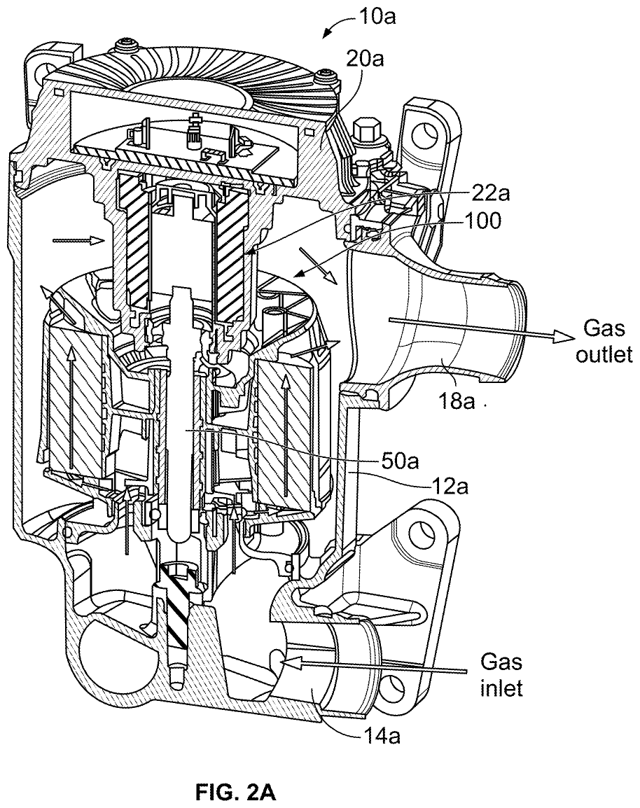

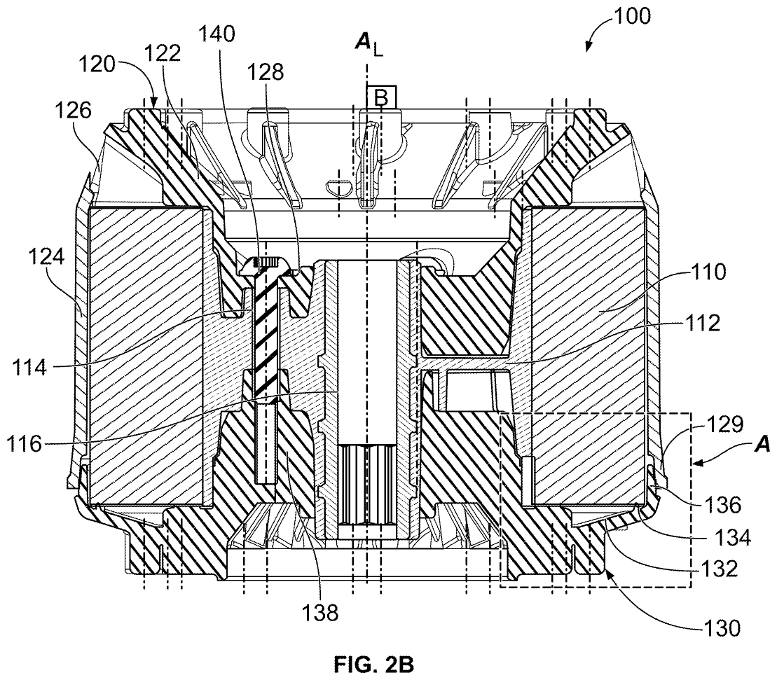

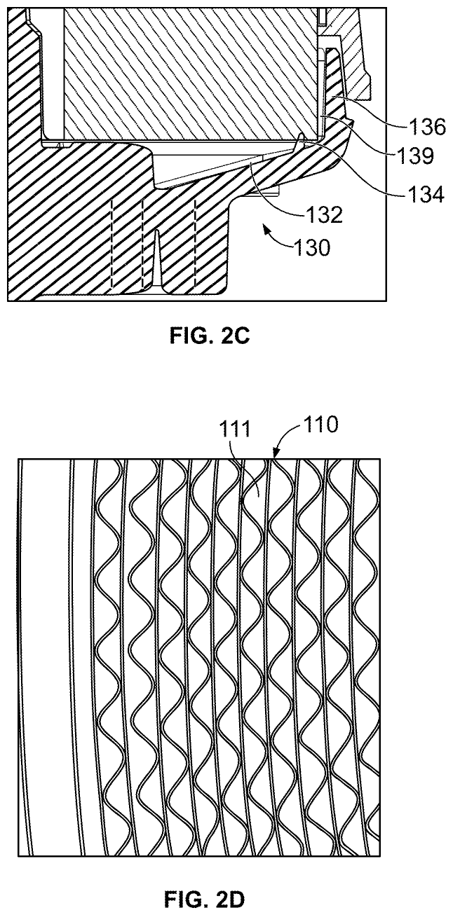

Referring to FIG. 2A, a cross-sectional view of a crankcase ventilation system 10a is shown according to another embodiment. The crankcase ventilation system 10a includes a rotating crankcase ventilation filter element 100 (e.g., a rotating coalescer element) according to the present disclosure, which is described further with respect to FIGS. 2B-2D. The crankcase ventilation system 10a generally processes blowby gases received from an internal combustion engine crankcase to remove aerosols, oils, and other particulate contained in the crankcase blowby gases. The crankcase ventilation system 10a generally includes a housing 12a having an inlet 14a that receives crankcase blowby gases to be filtered (e.g., from a crankcase of an internal combustion engine), a central compartment having a rotating crankcase ventilation filter element 100, for example, a rotating coalescer element installed therein, and an outlet 18a that provides filtered blowby gases to the internal combustion engine (in a closed crankcase ventilation system) or to the ambient (in an open crankcase ventilation system).

During operation of the crankcase ventilation system 10a, blowby gases enter the housing 12a through the inlet 14a. Different from the system 10, the blowby gases are directed to the central compartment where the blowby gases flow axially through the filter element 100, as indicated by the flow direction arrows shown in FIG. 2B. The filter element 100 may be coupled to a central shaft 50a that transfers rotation to the filter element 100. The central shaft 50a is rotationally driven by a motor 22a disposed in a portion of a cover 20a coupled to the housing 12a, which extends into the internal volume defined by the housing 12a. As the filter element 100 rotates, the filter element 100 (e.g., a rotating coalescer element) separates oil, aerosols, and other contaminants contained in the blowby gases. The separated contaminants drain from the housing 12a (e.g., through a drain) and return to an engine crankcase sump (e.g., the crankcase sump 28).

FIG. 2B is a side cross-section view of a filter element 100 that may be used as the filter element in the crankcase ventilation system 10 or 10a, according to an embodiment. The filter element 100 may be used to filter a fluid, for example air, fuel, air-fuel mixture, blowby gases or any other fluids used in an internal combustion engines. The filter element 100 comprises a filter media 110, a hub 112, a first endcap 120 (e.g., a top endcap), and a second endcap 130 (e.g., a bottom endcap) coupled to the first endcap. In particular embodiments, the filter element 100 comprises a rotating crankcase ventilation filter element. In such embodiments, the filter element 100 may be configured to filter crankcase blowby gases received from the internal combustion engine crankcase, for example, to remove aerosols, oils, and other particulate contained in the crankcase blowby gases. In various embodiments, the filter element 100 may be mounted or coupled to the central shaft 50. The central shaft 50 may be operatively coupled to a motor (e.g., a DC motor) or turbine and configured to rotate the filter element 100, for example, to facilitate centrifugal separation of aerosols, oils, water, etc. from the blowby gases.

The filter media 110 is positioned along a longitudinal axis A_{L} of the filter element 100. In some embodiments, the filter media 110 may include a corrugated and wound filter media configured for axial flow. For example, FIG. 2D shows a top view of a portion of the filter media 110. The filter media 110 includes a plurality of filter media layers 111 formed by winding or rolling a single layer of filter media 110 into a cylindrical shape. In various embodiments, the filter media 110 may be configured for axial flow. For example, the corrugations of the plurality of filter media layers 111 may define axial flow channels therebetween so as to allow axial flow of the gas through the axial flow channels. As previously described, the filter element 100 may include a rotating crankcase ventilation filter element mounted on the central shaft 50 configured to rotate the filter element 100. The rotation may cause oil, particles or other contaminants included in the fluid (e.g., blowby gases) flowing through the channels formed between the plurality of layers 111 of the filter media 110 to coalesce. The coalesced droplets are then removed from the filter element 100.

The filter media 110 is wound around an outer periphery of the hub 112. The hub 112 defines a central channel 116 that may configured to receive the central shaft 50 or 50a for mounting the hub 112 and thereby, the filter element 100 on the central shaft 50/50a. The hub 112 also defines at least one hub throughhole 114. The at least one hub throughhole 114 is structured to axially align with corresponding throughholes defined in a first coupling portion 128 of the first endcap 120 and a second coupling portion 138 of the second endcap 130 such that the portion/s of the hub 112 defining the at least one hub throughhole 114 is interposed between the first coupling portion 128 and the second coupling portion 138. A coupling member 140 (e.g., a screw, a bolt, a pin, a rivet, etc.) may be inserted through the throughholes defined in the first coupling portion 128, the second coupling portion 138, and the hub throughhole 114 so as to couple the first endcap 120 to the second endcap 130 and secure the hub 112 and therefore, the filter media 110 therebetween.

The first endcap 120 is positioned on a filter media first end (e.g., a top end) of the filter media 110. The first endcap 120 may include a first endcap main body 122, and a first sidewall 124 extending axially from an outer periphery of the first endcap main body towards the second endcap 130 such that the first endcap 120 defines a portion of an inner volume within which at least a portion of the filter media 110 and the hub 112 is disposed. A plurality of radial flow channels 126 are defined in the first endcap 120 to allow dirty fluid to enter the filter media 110 therethrough, or alternatively, allow clean fluid to exit the filter element 100. The first endcap 120 may be formed from a strong and rigid material, for example plastics (e.g., polypropylene, high density polyethylene, polyvinyl chloride, etc.), metals (e.g., aluminum, stainless steel, etc.), polymers (e.g., reinforced rubber, silicone) or any other suitable material.

The second endcap 130 is positioned on a filter media second end of the filter media 110 opposite the filter media first end. The second endcap 130 is coupled to the first endcap 120 such that the first endcap 120 and the second endcap 130 define the internal volume within which the filter media 110 is disposed. For example, a second sidewall 136 projects axially from an outer periphery of the second endcap 130 radially outwards of the filter media 110, towards the first endcap 120. The second sidewall 136 is configured to engage a proximate end 129 of the first sidewall 124, for example, snap-lock to, friction fit with, or generally, contact the proximate end 129 so as to define an enclosed volume within which the filter media 110 is disposed. The second endcap 130 may be formed from a strong and rigid material, for example plastics (e.g., polypropylene, high density polyethylene, polyvinyl chloride, etc.), metals (e.g., aluminum, stainless steel, etc.), polymers (e.g., reinforced rubber, silicone) or any other suitable material.

In some filter elements, a second sidewall (e.g., the second sidewall 136) is configured to form a radial seal with the filter media 110, which can cause uneven channel collapse of the filter media 110 causing the filter media 110 to go out of balance during rotation. In contrast, a radial gap 139 is present between the second sidewall 136 and a radially outer surface of the filter media 110. Instead, the second endcap 130 of the filter element includes an axial seal member 134 that extends from a surface 132 of the second endcap 130 towards the filter media 110 and forms an axial seal with the filter media 110. The axial seal member 134 projects or extends substantially parallel to a direction of axial fluid flow entering the filter media 110, as shown in FIG. 2A. As shown in FIG. 2B and 2C, the axial seal member 134 is located proximate to, and radially inwards of the second sidewall 136. In various embodiments, the axial seal member 134 may include a seal bead that is disposed circumferentially around the longitudinal axis A_{L}.

The axial seal member 134 is in contact (i.e., touching) with the filter media 110 or is in slight interference with (i.e., projects axially inwards into the filter media 110 and may compress or crimp corresponding portions of the filter media 110). This creates a barrier for the blowby gas and prevents the blowby gases from bypassing the filter media 110. In some embodiments, the axial interference of the axial seal member 134 with the filter media 110 may be in a range of 0.0 millimeters (mm) to 0.8 mm, and may be controlled by adjusting the tightening of the coupling member 140, i.e., higher tightening of the coupling member 140 may pull the second endcap 130 closer towards the first endcap 120 and increase interference depth, i.e., the depth to which the axial seal member 134 penetrates into the filter media 110. In other embodiments, interference may be achieved by snap fitting of the second sidewall 136 to the proximate end 129 of the first sidewall 124. FIG. 8 is a plot of separation or filtering efficiency of the filter element 100 that forms an axial seal as a function of interference depth (axial seal interference) of the axial seal member 134 of the second endcap 130 with the filter media 110. Separation efficiency increases from 98.4% at 0.2 mm interference depth and peaks at 0.8 mm interference depth where a separation efficiency of about 99.5% is observed. However, increase in interference depth beyond 0.8 mm does not result in further increase of separation efficiency.

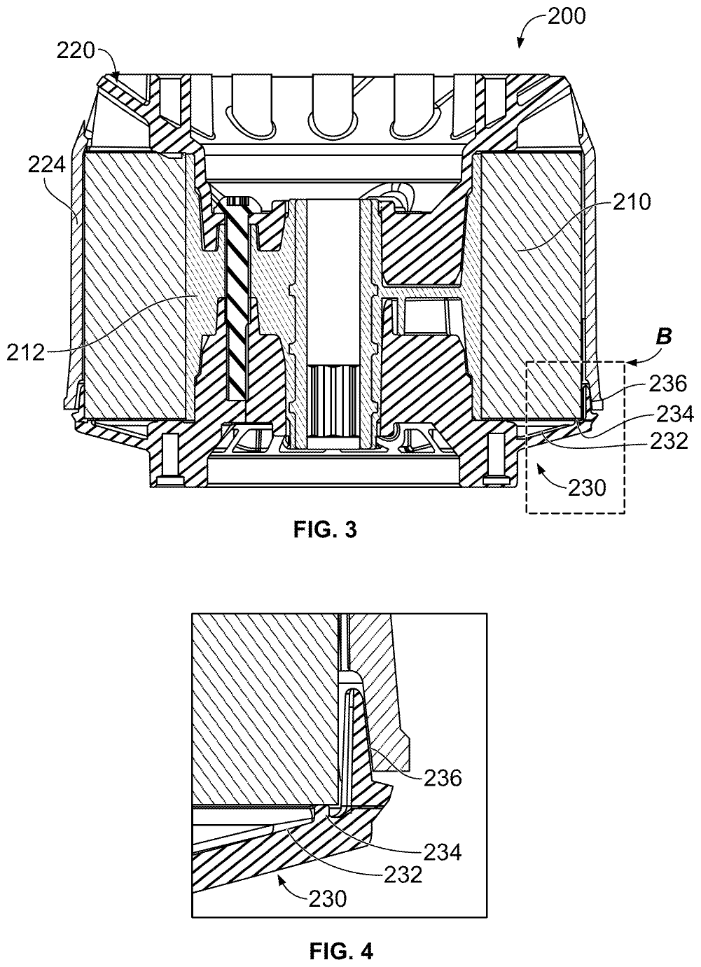

As shown in FIGS. 2B-2C, the axial seal member 134 has a triangular shape and have a sharp tip that contacts the filter media 110. In other embodiments, the axial seal member may have a dull or flat tip. For example, FIG. 3 is a side cross-section view of the filter element 200, according to another embodiment. The filter element 200 includes a filter media 210, a hub 212, a first endcap 220, and a second endcap 230. The filter media 210, the hub 212, and the first endcap 220 may be substantially similar to the filter media 110, the hub 112, and the first endcap 120, respectively, and are not described in further detail herein.

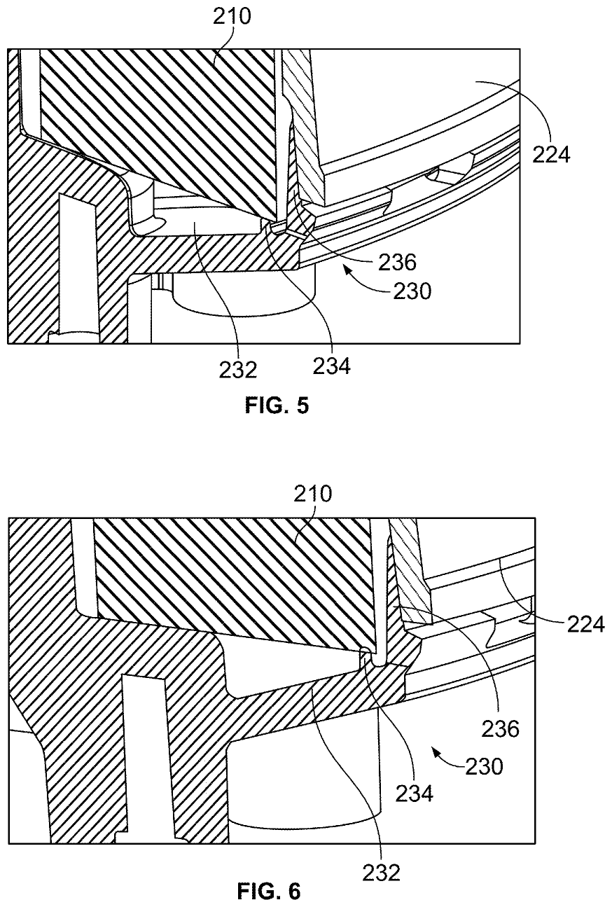

Referring to FIGS. 4-5, the second endcap 230 of the filter element 200 of FIG. 3. includes an axial seal member 234 that extends from a surface 232 of the second endcap 230 towards the filter media 210 and forms an axial seal with the filter media 210. The axial seal member 234 is located proximate to, and radially inwards of the second sidewall 236. The axial seal member 234 projects or extends substantially parallel to a direction of axial fluid flow entering the filter media 210, as shown in FIG. 2A. In various embodiments, the axial seal member 234 may include a seal bead that is disposed circumferentially around the longitudinal axis A_{L}. Different form the axial seal member 134 of FIG. 2C, a tip of the axial seal member 234 is dull or flat. The dull or flat shaped tip of the axial seal member 234 may reduce damage to the filter media 210 and/or reduce telescoping of the layers of the filter media 210 relative to the sharp tipped axial seal member 134, due to interference of the axial seal member 234 with the filter media 210. FIG. 5 shows a configuration of the filter element 200 in which the axial seal member 234 contacts the filter media 210 without any interference, i.e., does not penetrate into the filter media 210. FIG. 6 shows another configuration of the filter element 200 in which the axial seal member 234 interferes with the filter media 210 (e.g., penetrates up to an interference depth of 0.2 mm to a 0.8 mm into the filter media 210).

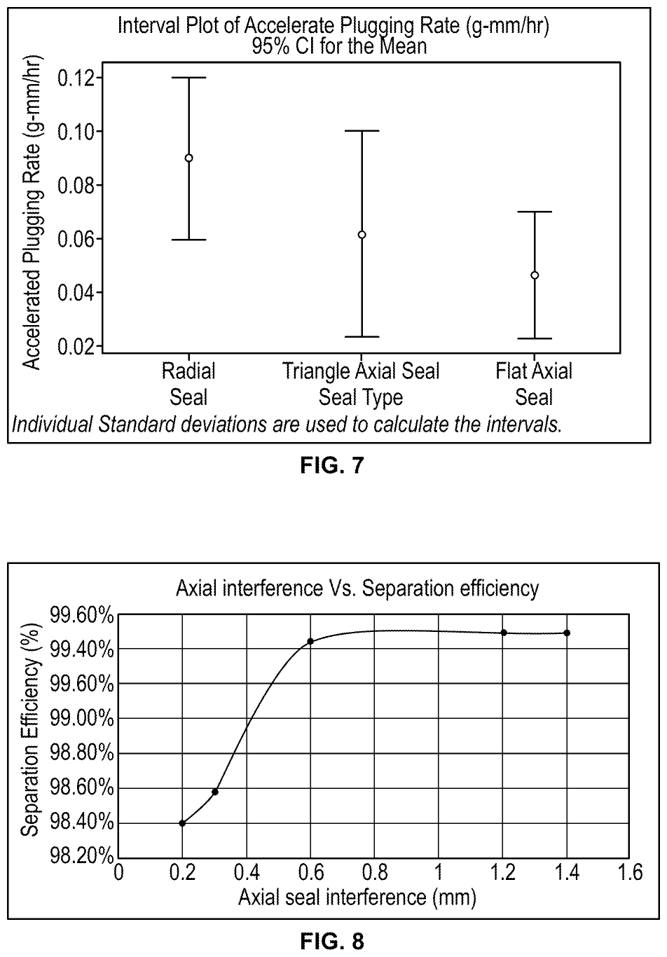

The axial seal members 134, 234 do not cause an uneven collapse of channels of the filter media 110, which greatly reduces the risk of the filter media 110 becoming out of balance, as is the case with endcaps forming radial seal with the filter media 110. For example, FIG. 7 is a plot of out of balance rate of increase for a second endcap of a filter element that forms a radial seal with the filter media 110 included in the filter element 100, the second endcap 130 that forms an axial seal via a triangular axial seal member 134, and the second endcap 230 that forms an axial seal via a flat axial seal member 234, with the filter media 110 included in the filter element 100. Based on results from an accelerated test to simulate media plugging overtime with contaminants, the mean out of balance rate for the second endcap that forms a radial seal is about 0.09 g-mm/h at a confidence interval of about ±0.025 g-mm/h. In contrast, the mean out of balance rate for the second endcap 130 that forms an axial seal via the triangular seal member 134 is about 0.06 g-mm/h at a confidence interval of ±0.04 g-mm/h, and the mean out of balance rate for the second endcap 230 that forms an axial seal via the flat axial seal member 234 is about 0.05 g-mm/h at a confidence interval of ±0.02 g-mm/h. both of which are significantly lower than the mean radial seal out of balance rate.

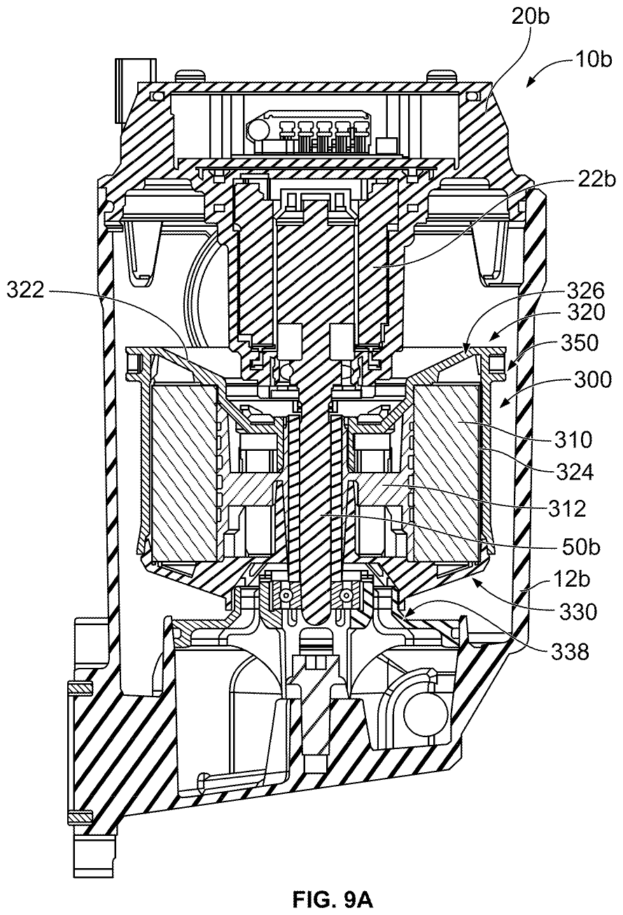

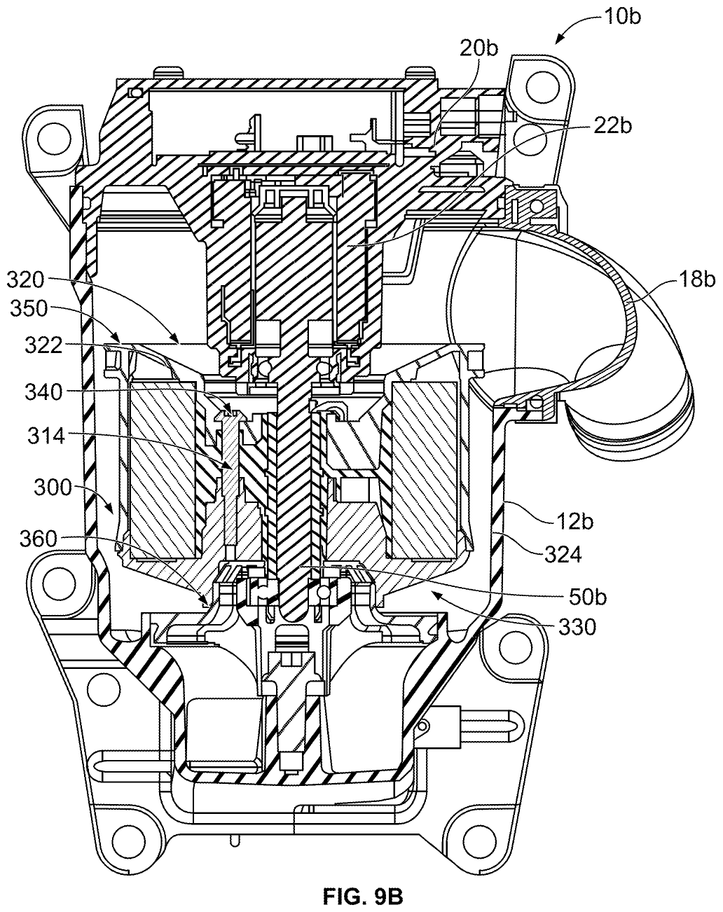

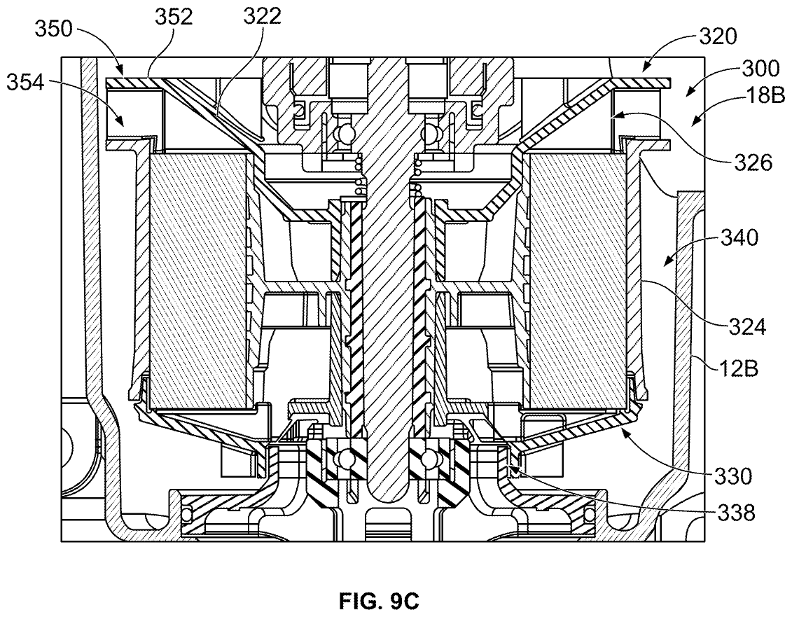

Referring to FIGS. 9A and 9B, cross-sectional views of a crankcase ventilation system 10b are shown, according to another embodiment. The crankcase ventilation system 10b is similar in many respects to the crankcase ventilation system 10/10a, described herein with respect to FIGS. 1 and 2A. For example, the crankcase ventilation system 10b generally processes blowby gases received from an internal combustion engine crankcase to remove aerosols, oils, and other particulate contained in the crankcase blowby gases. The crankcase ventilation system 10b generally includes a housing 12b having an inlet (not shown) that receives crankcase blowby gases to be filtered (e.g., from a crankcase of an internal combustion engine), a central compartment having a rotating crankcase ventilation filter element 300, for example, a rotating coalescer element installed therein, and an outlet 18b that provides filtered blowby gases to the internal combustion engine (in a closed crankcase ventilation system) or to the ambient (in an open crankcase ventilation system).

During operation of the crankcase ventilation system 10a, blowby gases enter the housing 12b through the inlet. Different from the systems 10/10a, the crankcase ventilation system 10b includes a rotating crankcase ventilation filter element 300 (e.g., a rotating coalescer element) according to the present disclosure. The filter element 300 is substantially similar to or the same as the filter element 100/200, described herein with respect to FIGS. 2A-4. Similar to the system 10a, the blowby gases are directed to the central compartment where the blowby gases flow axially through the filter element 300.

The filter element 300 may be coupled to a central shaft 50b that transfers rotation to the filter element 300. The central shaft 50a is rotationally driven by a motor 22b disposed in a portion of a cover 20b coupled to the housing 12b, which extends into the internal volume defined by the housing 12b. As the filter element 300 rotates, the filter element 300 (e.g., a rotating coalescer element) separates oil, aerosols, and other contaminants contained in the blowby gases. The separated contaminants drain from the housing 12b (e.g., through a drain) and return to an engine crankcase sump or a crankcase sump.

The filter element 300 includes a filter media 310, a hub 312, a first endcap 320, and a second endcap 330. The filter media 310 and the hub 312 may be substantially similar to the filter media 110/210 and the hub 112/212, respectively, and are not described in further detail herein. The first endcap 320 may be substantially similar to the first endcap 120/220. For example, the first endcap 320 includes a first endcap main body 322, a first sidewall 324, and radial flow channels 326 that are substantially similar to the first endcap main body 122/222, the first sidewall 124/224, and the radial flow channels 126/226 respectively. Different from the first endcap 120/220, the first endcap 320 includes a fan 350 disposed around a periphery of the first endcap main body 322. The fan 350 is described in greater detail herein with respect to FIG. 9C. The second endcap 330 may be substantially similar to the second endcap 130 or the second endcap 230. For example, the second endcap 330 may include an axial seal member 334 that extends from a surface 332 of the second endcap 330 towards the filter media 310 and forms an axial seal with the filter media 310. The axial seal member 334 may have a triangular shape (e.g., a sharp tip) that contacts the filter media 310 similar to the axial seal member 134, or the axial seal member 334 may have a dull or flat tip, similar to the axial seal member 234.

Now referring to FIG. 9C, a side cross-section view of a portion of the filter element 300 of FIGS. 9A and 9B is shown. The fan 350 includes a fan wall 352 that extends radially away from the first endcap main body 322. The fan wall 352 may include an upper portion that is continuous with the first endcap main body 322 and a lower portion that is continuous with the first sidewall 324. The fan wall 352 defines one or more radial passages 354 that are in fluid receiving communication with one or more of the radial flow channels 326 and fluid providing communication with the central compartment of the housing 12b.

The fan 350 causes the fluid received from the radial flow channels 326 to flow along a first flow path (e.g., a recirculation flow path) and a second flow path (e.g., an exhaust flow path). The first flow path is defined by an inner surface of the housing 12b, an outer surface of the first sidewall 324, and the second endcap 330. As the fluid flows along the first flow path, the fluid passes through a gap between the first sidewall 324 and housing 12b. The fluid then enters the filter element 300 via an inlet 338 defined by the second endcap 330. The second flow path is defined by the outlet 18b. As the fluid flows along the second flow path, the fluid exits the crankcase ventilation system 10b via the outlet 18b.

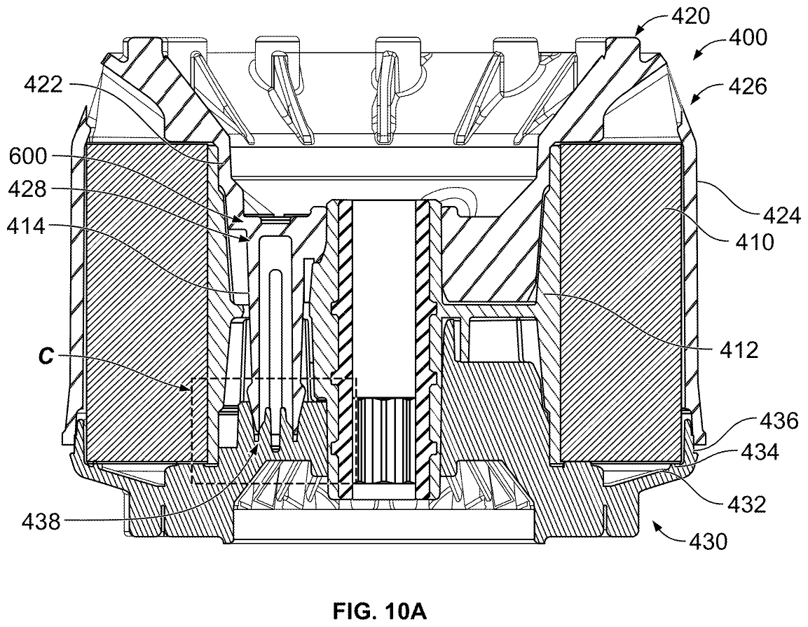

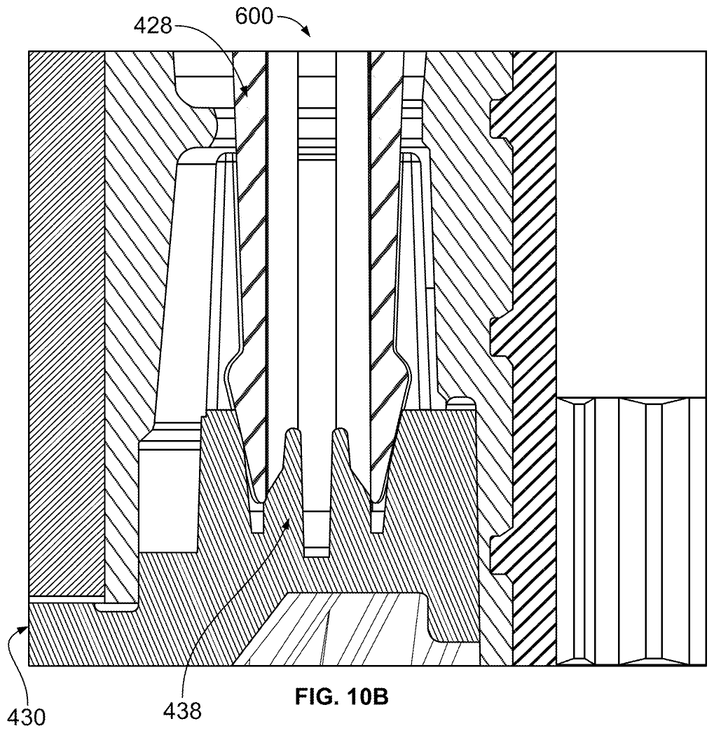

Now referring to FIGS. 10A and 10B, a side cross-section view of a filter element 400 that may be included in any of the crankcase ventilation system described herein and a portion of the filter element of FIG. 10A indicated by the arrow C are shown, according to an embodiment. The filter element 400 includes a filter media 410, a hub 412, a first endcap 420, and a second endcap 430. The filter media 410 and the hub 412 may be substantially similar to the filter media 110/210/310 and the hub 112/212/312, respectively. For example, the hub 412 defines at least one hub throughhole 414.

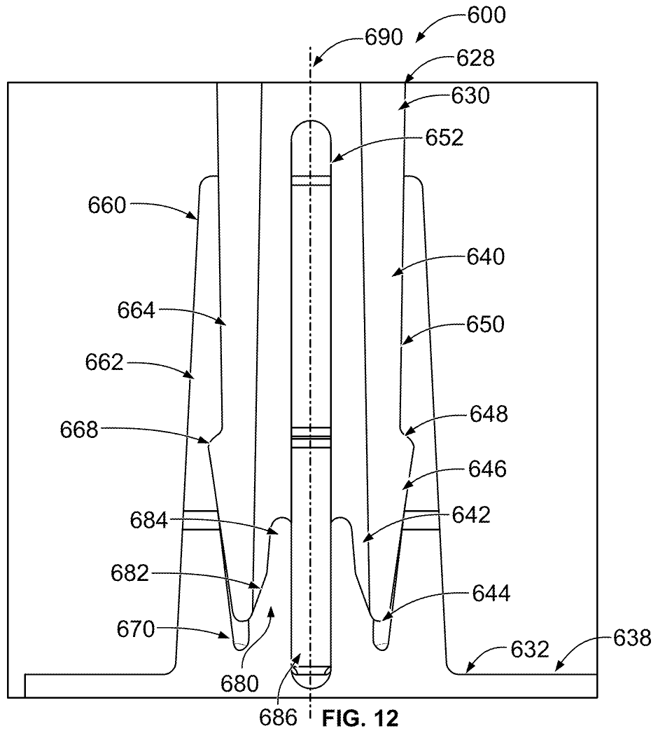

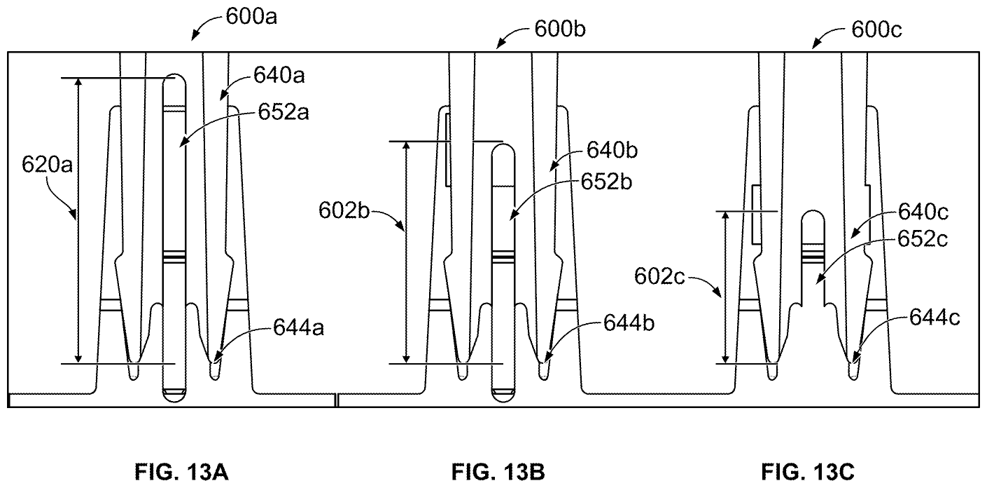

The first endcap 420 may be substantially similar to the first endcap 120/220/320. For example, the first endcap 420 includes a first endcap main body 422, a first sidewall 424, and a plurality of radial flow channels 426 that are substantially similar to the first endcap main body 122/222/322, the first sidewall 124/224/324, and the radial flow channels 126/226/326, respectively. Different from first endcap 120/220/320, the first endcap 420 includes a first coupling portion 428 that is part of a snap-fit engagement structure 600. The engagement structure 600 is described in greater detail herein with respect to FIGS. 12-13C.

The second endcap 430 may be substantially similar to the second endcap 130/230/330. For example, the second endcap 430 may include an axial seal member 434 that extends from a surface 432 of the second endcap 430 towards the filter media 410 and forms an axial seal with the filter media 410. The axial seal member 434 may have a triangular shape (e.g., a sharp tip) that contacts the filter media 410 similar to the axial seal member 134, or the axial seal member 434 may have a dull or flat tip, similar to the axial seal member 234. Different from the second endcap 130/230/330, the second endcap 430 includes a second coupling portion 438 that is part of the snap-fit engagement structure 600.

The at least one hub throughhole 414 is structured to axially align with the first coupling portion 428 of the first endcap 420 and the second coupling portion 438 of the second endcap 430. The first coupling portion 428 of the first endcap 420 and the second coupling portion 438 of the second endcap 430 extend, at least partially, through the at least one hub throughhole 414, such that the first coupling portion 428 engages the second coupling portion 438.

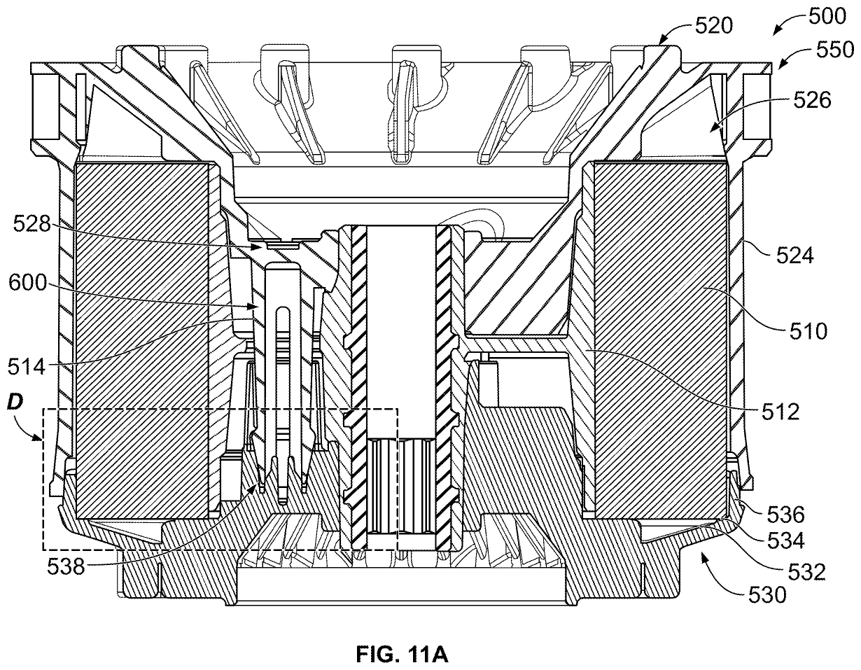

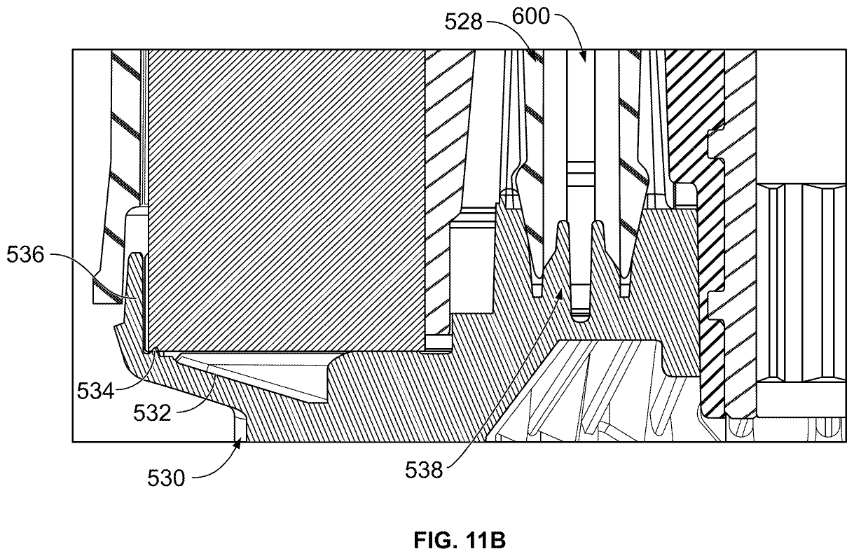

Now referring to FIGS. 11A and 11B, a side cross-section view of a filter element 500 that may be included in any of the crankcase ventilation system described herein and a portion of the filter element of FIG. 11A indicated by the arrow D are shown, according to an embodiment. The filter element 500 includes a filter media 510, a hub 512, a first endcap 520, and a second endcap 530. The filter media 510, the hub 512, and the second endcap 530 may be substantially similar to the filter media 410, the hub 412, and the second endcap 430, respectively. For example, the hub 512 defines at least one hub throughhole 514.

The first endcap 520 may be substantially similar to the first endcap 420. For example, the first endcap 520 includes a first endcap main body 522, a first sidewall 524, a plurality of radial flow channels 526, and a first coupling portion 528 that are substantially similar to the first endcap main body 422, the first sidewall 424, the radial flow channels 426, and the first coupling portion 428, respectively. Different from first endcap 420, the first endcap 520 includes a fan 550 that is substantially similar to the fan 350, described herein with respect to FIGS. 9A-9C.

FIG. 12 is a side cross-section view of a snap-fit engagement structure 600 that may be included in the filter element 400/500, according to an embodiment. The engagement structure 600 includes a first coupling portion 628 (e.g., the first coupling portion 428/528) and a second coupling portion 638 (e.g., the second coupling portion 438/538). The first coupling portion 628 may be part of a first endcap (e.g., the first endcap 420/520). The second coupling portion 638 may be part of a second endcap (e.g., the second endcap 430/530). The first coupling portion 628 engages the second coupling portion 638 in a snap fit arrangement such that the first endcap 420/520 is coupled to the second endcap 430/530. The first coupling portion 628 and the second coupling portion 638 are axially aligned with a throughhole of a hub (e.g., the throughhole 414/514 of the hub 412/512) on an axis 690.

The first coupling portion 628 includes a first engagement body 630. The first engagement body 630 may extend axially away from the first endcap 420/520 and towards the second endcap 430/530. The first coupling portion 628 includes one or more pronged members 640 that extend axially away from the first engagement body 630.

The one or more pronged members 640 include an inner portion 642, a tip portion 644, an angled portion 646, a shoulder 648, and an outer portion 650. The inner portion 642 defines an inner surface of the one or more pronged members 640 and extends axially between the first engagement body 630 and the tip portion 644. The inner portion 642 is substantially parallel to the axis 690. The tip portion is disposed at a distal end of the one or more pronged members 640. The angled portion 646 extends axially and radially (e.g., oblique to and radially away from the axis 690) away from the tip portion 644 towards the shoulder 648. The shoulder 648 extends axially and radially away from the tip portion 644 (e.g., oblique to and radially towards the axis 690). The shoulder 648 defines a recess that is configured to receive a portion of the second coupling portion 638. The outer portion 650 defines an outer surface of the one or more pronged members 640 and extends axially between the first engagement body 630 and the shoulder 648. The outer portion 650 is substantially parallel to the axis 690.

The one or more pronged members 640 define a gap 652 therebetween. The gap extends axially from a proximal end of the one or more pronged members 640 towards a distal end of the one or more pronged members 640. The proximal end of the one or more pronged members 640 is defined at the first engagement body 630.

The second coupling portion 638 includes a second engagement body 632. The second engagement body 632 may be part of the second endcap 430/530. The second coupling portion 638 includes an outer wall 660 and an inner wall 680. A channel 670 is defined between the outer wall 660 and the inner wall 680. The channel 670 receives at least a portion of the one or more pronged members 640 therein.

The outer wall 660 extends axially away from the second engagement body 632 (e.g., towards the first endcap 420/520). The outer wall 660 may be cylindrical in shape or may be tapered such that a cross sectional diameter of the outer wall 660 decreases along the axial length of the outer wall 660. The outer wall 660 includes an outer surface 662, an inner surface 664. As shown in FIG. 12, the outer surface 662 is oblique relative to the axis 690.

The inner surface 664 defines a recess 668. The recess 668 is configured to receive the shoulder 648. The inner surface 664 contacts the shoulder 648 of the one or more pronged members 640 at the recess 668. The inner surface 664 may contact the one or more pronged members 640 and apply a force radially inwards and axially towards the second endcap 430/530 thereto. In some embodiments, the force at least partially deflects the one or more pronged members 640 radially inwards (e.g., towards the axis 690) such that the one or more pronged members 640 are retained by the second coupling portion 638 in a snap-fit arrangement.

A first portion (e.g., a portion above the recess 668) of the inner surface 664 is substantially parallel to the axis 690. A second portion (e.g., a portion below the recess 668) of the inner surface 664 is oblique relative to the axis 690. The second portion of the inner surface 664 is substantially parallel to the angled portion 646 of the one or more pronged members 640.

The inner wall 680 includes a proximal portion 682 and a distal portion 684. The proximal portion 682 is angled relative to the axis 690. For example a first angle may be defined between the proximal portion 682 and the axis 690. The first angle may be between 90° and 180°, or more specifically, between 160° and 165°, inclusive. The proximal portion 682 may contact at least a portion of the one or more pronged members 640, when the one or more pronged members 640 are received in the channel 670. The proximal portion 682 may contact the one or more pronged members 640 and apply a force radially outwards thereto. In some embodiments, the force at least partially deflects the one or more pronged members 640 radially outwards (e.g., away from the axis 690) such that the one or more pronged members 640 are retained by the second coupling portion 638 in a snap-fit arrangement.

In some embodiments, the inner wall 680 is hollow, such that the inner wall 680 defines a central opening 686 that is axially aligned with the axis 690. In other embodiments, the inner wall 680 is not hollow.

FIGS. 13A-13C are side cross-section views of the snap fit feature of FIG. 12, according to various embodiments. In a first embodiment, the pronged members 640a of the engagement structure 600a have a first axial length 602a (approximately 25.4 millimeters (mm) in a particular implementation). The first axial length 602a is measured from a proximal end of the pronged member 640a (e.g., at the opening of the gap 652a) to a distal end of the pronged member 640a (e.g., at the tip 644a). In a particular implementation of the first embodiment, the engagement structure 600a may have a retention force of approximately 96 pounds (lb) force.

In a second embodiment, the pronged members 640b of the engagement structure 600b have a second axial length 602b (approximately 19.05 mm in a particular implementation). The second axial length 602b is measured from a proximal end of the pronged member 640b (e.g., at the opening of the gap 652b) to a distal end of the pronged member 640b (e.g., at the tip 644b). In a particular implementation of the second embodiment, the engagement structure 600b may have a retention force of approximately 117 lb.

In a third embodiment, the pronged members 640c of the engagement structure 600c have a third axial length 602c (approximately 12.7 mm in a particular implementation). The third axial length 602c is measured from a proximal end of the pronged member 640c (e.g., at the opening of the gap 652c) to a distal end of the pronged member 640c (e.g., at the tip 644c). In a particular implementation of the third embodiment, the engagement structure 600c may have a retention force of approximately 147 lb.

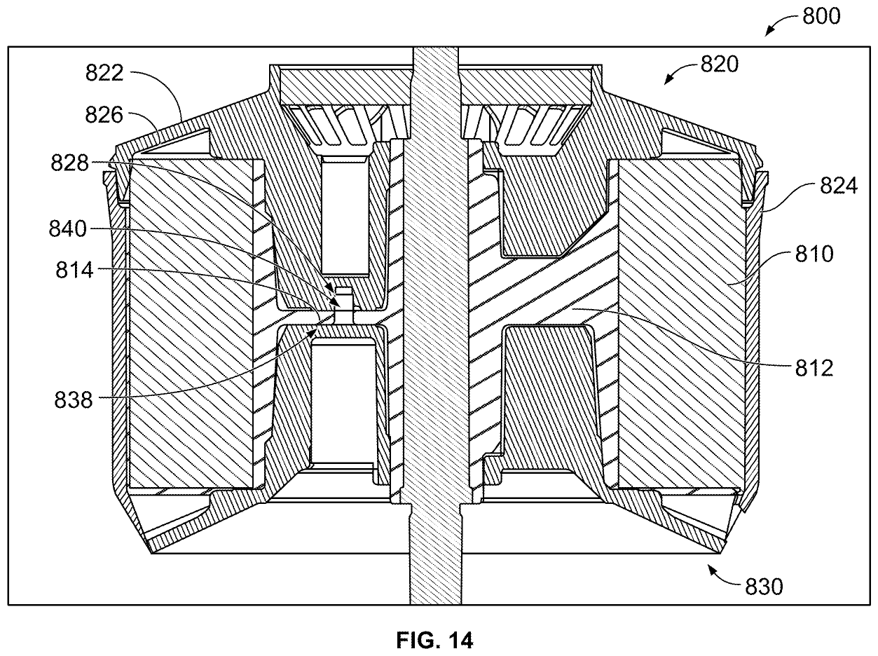

FIG. 14 is a side cross-section view of a filter element 800 that may be included in any of the crankcase ventilation system described herein, according to an embodiment. The filter element 800 includes a filter media 810, a hub 812, a first endcap 820, and a second endcap 830. The filter media 810 and the hub 812 may be substantially similar to the filter media 110/210/310/410/510 and the hub 112/212/312/412/512, respectively. For example, the hub 812 defines at least one hub throughhole 814.

The first endcap 820 may be substantially similar to the first endcap 120/220/320/420/520. For example, the first endcap 820 includes a first endcap main body 822, a first sidewall 824, and a plurality of radial flow channels 826 that are substantially similar to the first endcap main body 122/222/322/422/522, the first sidewall 124/224/324/424/524, and the radial flow channels 126/226/326/426/526, respectively. Different from first endcap 120/220/320/420/520, the first endcap 820 includes a first coupling portion 828. The first coupling portion 828 is described in greater detail herein below.

The second endcap 830 may be substantially similar to the second endcap 130/230/330/430/530. Different from the second endcap 130/230/330/430/530, the second endcap 830 includes a second coupling portion 838.

The at least one hub throughhole 814 is structured to axially align with the first coupling portion 828 of the first endcap 820 and the second coupling portion 838 of the second endcap 830. An axial member 840 may extend through the throughhole 814 and contact the first coupling portion 828 of the first endcap 820 and the second coupling portion 838 of the second endcap 430. The axial member 840 may be coupled to the hub 812, the first endcap 820, and/or the second endcap 830 such that the first endcap 820 is coupled to the second endcap 830. The axial member 840 may be coupled to the hub 812, the first endcap 820, and/or the second endcap 830 by a welding process.

In some embodiments, the filter element 100/200/300/400/500/800 may be configured to removably couple to the central shaft 50/50a/50b. In other embodiments, the filter element 100/200/300/400/500/800 may be fixed to the central shaft 50/50a/50b.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

As utilized herein, the term “substantially” and any similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided unless otherwise noted. Accordingly, these terms should be interpreted as indicating that insubstantial or inconsequential modifications or alterations of the subject matter described and claimed are considered to be within the scope of the invention as recited in the appended claims.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the embodiments described herein.

While this specification contains many specific implementation details, these should not be construed as limitations on the scope of any embodiment or of what may be claimed, but rather as descriptions of features specific to particular implementations of particular embodiments. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A rotating crankcase ventilation filter element, comprising:
a filter media;
a first endcap positioned on a filter media first end of the filter media; and
a second endcap positioned on a filter media second end of the filter media, the second endcap coupled to the first endcap such that the first endcap and the second endcap define an internal volume within which the filter media is disposed, the second endcap comprising an axial seal member extending from a surface of the second endcap towards the filter media and forming an axial seal with the filter media, the axial seal member projecting substantially parallel to a direction of axial fluid flow entering the filter media.

2. The rotating crankcase ventilation filter element of claim 1, wherein:
the first endcap comprises:
a first endcap main body, and
a first sidewall extending axially from an outer periphery of the first endcap main body towards the second endcap; and
the second endcap comprises a second sidewall extending from an outer periphery of the second endcap towards the first endcap and contacting a proximate end of the first sidewall.

3. The rotating crankcase ventilation filter element of claim 2, wherein a radial gap is present between the second sidewall and a radially outer surface of the filter media.

4. The rotating crankcase ventilation filter element of claim 2, wherein the axial seal member is located proximate to and radially inwards of the second sidewall.

5. The. rotating crankcase ventilation filter element of claim 2, wherein the first endcap further comprises:
a plurality of radial flow channels; and
a fan disposed around a periphery of the first endcap main body, the fan comprising a fan wall that extends radially away from the first endcap main body, wherein the fan is in fluid receiving communication with one or more of the plurality of radial flow channels.

6. The rotating crankcase ventilation filter element of claim 1, wherein:
the first endcap further comprises a first coupling portion;
the second endcap comprises a second coupling portion;
the first coupling portion and the second coupling portion at least partially define a throughhole; and
the rotating crankcase ventilation filter element comprises a coupling member extending through the throughhole and coupling the first endcap to the second endcap.

7. The rotating crankcase ventilation filter element of claim 1, wherein:
the first endcap comprises a first coupling portion; and
the second endcap comprises a second coupling portion structured to receive the first coupling portion in a snap-fit arrangement.

8. The rotating crankcase ventilation filter element of claim 1, wherein the first endcap is welded to the second endcap.

9. The rotating crankcase ventilation filter element of claim 1, wherein the axial seal member has a triangular shape defining a sharp tip that contacts the filter media.

10. The rotating crankcase ventilation filter element of claim 8, wherein an axial interference of the axial seal member with the filter media is from 0.0 millimeters (mm) to 0.8 mm.

11. The rotating crankcase ventilation filter element of claim 1, wherein the axial seal member has a flat shape that contacts the filter media without interference.

12. A crankcase ventilation system comprising:
a housing having an inlet that receives a fluid and an outlet;
a rotating crankcase ventilation filter element comprising:
a filter media;
a first endcap positioned on a filter media first end of the filter media; and
a second endcap positioned on a filter media second end of the filter media, the second endcap coupled to the first endcap such that the first endcap and the second endcap define an internal volume within which the filter media is disposed, the second endcap comprising an axial seal member extending from a surface of the second endcap towards the filter media and forming an axial seal with the filter media, the axial seal member projecting substantially parallel to a direction of axial fluid flow entering the filter media.

13. The crankcase ventilation system of claim 12, wherein
the first endcap comprises:
a first endcap main body, and
a first sidewall extending axially from an outer periphery of the first endcap main body towards the second endcap; and
the second endcap comprises a second sidewall extending from an outer periphery of the second endcap towards the first endcap and contacting a proximate end of the first sidewall.

14. The crankcase ventilation system of claim 13, wherein a radial gap is present between the second sidewall and a radially outer surface of the filter media.

15. The crankcase ventilation system of claim 13, wherein the axial seal member is located proximate to and radially inward of the second sidewall.

16. The crankcase ventilation system of claim 13, wherein the first endcap further comprises:
a plurality of radial flow channels; and
a fan disposed around a periphery of the first endcap main body, the fan comprising a fan wall that extends radially away from the first endcap main body, wherein the fain is in fluid receiving communication with one or more of the plurality of radial flow channels.

17. The crankcase ventilation system of claim 16, wherein the second endcap defines a second endcap inlet, and wherein the fan is in fluid providing communication with the outlet and the second endcap inlet.

18. The crankcase ventilation system of claim 12, wherein:
the first endcap further comprises a first coupling portion;
the second endcap comprises a second coupling portion;
the first coupling portion and the second coupling portion at least partially define a throughhole; and
the rotating crankcase ventilation filter element comprises a coupling member extending through the throughhole and coupling the first endcap to the second endcap.

19. The crankcase ventilation system of claim 12, wherein:
the first endcap comprises a first coupling portion; and
the second endcap comprises a second coupling portion structured to receive the first coupling portion in a snap-fit arrangement.

20. The crankcase ventilation system of claim 12, wherein the first endcap is welded to the second endcap.

21. The crankcase ventilation system of claim 12, wherein the axial seal member has a triangular shape defining a sharp tip that contacts the filter media.

22. The crankcase ventilation system of claim 12, wherein an axial interference of the axial seal member with the filter media is between 0.0 millimeters (mm) to 0.8 mm.

23. The crankcase ventilation system of claim 12, wherein the axial seal member has a flat shape that contacts the filter media without interference.

24. A rotating crankcase ventilation filter element comprising:
a filter media; and
an endcap positioned on a filter media end of the filter media, the endcap comprising:
an axial seal member extending from a surface of the endcap towards the filter media and forming an axial seal with the filter media, the axial seal member projecting substantially parallel to a direction of axial fluid flow entering the filter media; and
a sidewall extending from an outer periphery of the endcap towards the filter media, wherein a radial gap is defined between the sidewall and a radially outer surface of the filter media.
